(19) United States
(12) Patent Application Publication
(10) Pub. No.: US 2008/0142617 A1
(43) Pub. Date: Jun. 19, 2008

(54) Spray Device

(76) Inventors: Shoji Kasuya, Iwate (JP); Hiroshi Hashimoto, Iwate (JP); Shinichi Sekiguchi, Iwate (JP)

Correspondence Address: HARNESS, DICKEY & PIERCE, P.L.C., P.O. BOX 8910, RESTON, VA, 20195, US

(21) Appl. No.: 11/664,799

(22) PCT Filed: Oct. 5, 2005
(86) PCT No.: PCT/JP05/18455

§ 371 Date: Aug. 9, 2007

(30) Foreign Application Priority Data
Oct. 8, 2004 (JP) 2004-296433

(51) Int. Cl. B05B 1/00

(52) U.S. Cl. 239/169

(57) ABSTRACT

A spray device which can spray a liquid without using a pump and does not cause dripping of a material liquid at a spray port is provided.

The spray device comprises a housing 2, a material liquid tank 6 attached to or stored in the housing 2 and reserving a predetermined material liquid, a spray portion 20 having a spray port for spraying the material liquid to the outside, a liquid passage 8 having the material liquid tank 6 communicate with the spray portion 20, and liquid passing adjusting unit 10 for applying resistance to a flow of the material liquid in the liquid passage 8, and the liquid passage 8 is arranged so that the flow direction of the material liquid in the liquid passage 8 is coaxial with the spray direction of the spray portion 20.

### TECHNICAL FIELD

The present invention relates to a spray device for spraying a material liquid, which is an electrolyte solution of a medical agent used for cosmetic, hygienic or other applications or an electrolyte obtained by electrolyzing this.

### BACKGROUND ART

Spray devices in various forms for spraying a liquid such as a cosmetic liquid and an antiseptic solution have been known. This type of spray device generally comprises a housing, a material liquid tank attached to or stored in the housing and reserving a predetermined material liquid, a spray portion, a pump for pumping the material liquid to the spray portion or an electrolysis tank or the like in the device and the like so that spraying is effected from the spray portion to a human body or other spray targets.

FIGS. 9 and 10 show a conventional spray device (See Patent Document 1, for example), which is a type having an electrode for electrolyzing a water solution of an electrolyte. In FIG. 9, reference numeral 500 denotes a spray device, and an electrolytic water solution (material liquid) 504 in an electrolyte water solution tank (material liquid tank) 502 is sent to an electrolysis tank 508 by a pump 506 as liquid-supply unit and electrolyzed there. Anodic electrolyzed water (acid water) generated on an anode 602 (See FIG. 10) side in the electrolysis tank 508 is sprayed to the outside from a spray portion 510 (using a jet 604 shown in FIG. 10, for example) and applied to a spray target such as a skin. On the other hand, cathodic electrolyzed water (alkali water) generated on a cathode 600 (See FIG. 10) side in the electrolysis tank 508 is sent to a wastewater tank 514 through a drain pipe 512 and reserved in the wastewater tank 514 as a wastewater 516 temporarily. The spray portion 510 comprises, as shown in FIG. 10, for example, a porous spray plate 604 and a piezo oscillator 605 for vibrating the porous spray plate 604.

Patent Document Japanese Patent Laid-Open No. 2002-52069

### DISCLOSURE OF THE INVENTION

### Problem to be Solved by the Invention

In the above-mentioned conventional spray device, the pump 506 is used as liquid supply unit for supplying the material liquid 504 in the tank 502 into the electrolysis tank 508. This makes it sure that the material liquid 504 is surely supplied into the electrolysis tank 508 regardless of the location of the tank 502, and also because the electrolyte needs to be divided into the anode 602 side and the cathode 600 side substantially evenly by an orifice at an outlet of the electrolysis tank 508.

However, in the example of the above-mentioned spray device, since the pump 506 is used as liquid supply unit for supplying the material liquid 504 in the tank 502 into the electrolysis tank 508, the weight, volume and costs of the entire spray device 600 are increased by the portion for the pump 506 (including a driving portion for driving the pump 506). Also, an electric power needs to be supplied to the pump 506 as well as to the electrolysis tank 508 and a control device for controlling operation of the electrolysis tank 508, which increases power consumption of the spray device as a whole. Moreover, there is a problem that operation noise (ambient noise) or vibration is caused by driving of the pump 506.

Also, hydrogen gas and oxygen gas are generated on the surface of the electrode in the electrolysis tank 508 at electrolysis of the electrolyte, and if the electrolyte is pumped by the pump 506 in such a situation, when the outlet of the electrolysis tank 508 is narrowed by the orifice or the like, a time zone occurs when only the above gases generated on the electrode surface are discharged from the outlet of the electrolysis tank 508 intermittently, and a so-called air-lock phenomenon can easily occur in which the electrolyte is discharged from the spray portion 510 only intermittently.

Also, when the pump 506 is used, since a time is needed for filling the pump 506 and a liquid passage of the pump 506 with the electrolyte at initial liquid filling, there is a problem that the electrolyte can not be sprayed immediately after the liquid filling. Moreover, since it is difficult to wash the liquid passage, the liquid passage is extremely unsanitary. Moreover, there is a problem that the electrolyte remains in the pump 506, which makes efficient use of the electrolyte impossible.

The present invention was made in view of the above circumstances and has an object to provide a spray device which can spray a liquid without using a pump. Also, it has an object to provide a spray device which does not cause dripping of the material liquid at a spray port in spraying unit.

### Means for Solving the Problem

In order to solve the above problems, the present invention provides a spray device comprising a housing, a material liquid tank attached to or stored in the housing and reserving a predetermined material liquid, spray unit having a spray port for spraying the material liquid to the outside, a liquid passage for having the material liquid tank and the spray port communicate with each other, and liquid passing adjusting unit for applying resistance to flow of the material liquid in the liquid passage, in which the liquid passage is arranged so that a flowing direction of the material liquid in the liquid passage is coaxial with the spray direction of the spray port.

In the spray device as above, the liquid passage for communication between the material liquid tank and the spray port and the liquid passing adjusting unit for applying resistance to the flow of the material liquid in the liquid passage are provided, and there is no need to provide a pump for pumping the material liquid to the spray unit. If the pump is not provided, not only the weight, volume and costs of the entire spray device but power consumption of the entire device can be reduced. Also, operating noise (noise) or vibration caused by driving of the pump is eliminated and so-called air-lock phenomenon in use of the pump can be restricted.

Since the pump is not used in this embodiment as above, the material liquid tank is preferably arranged above the spray port so that the material liquid in the material liquid tank can be smoothly guided toward the spray port side by action of force of gravity.

The spray unit comprises a spray plate having a large number of fine holes and a vibrator for vibrating the spray plate. By this, the material liquid in the fine particle size can be sprayed.

The liquid passing adjusting unit is a liquid absorbing medium absorbing the material liquid from the material liquid tank. This liquid absorbing medium also has a function as liquid passing resistance unit, and when the porous spray plate is not vibrated, the unit applies a resistance force to the material liquid communicating through the liquid absorbing medium in order to restrict its outflow from the spray port, while if the porous spray plate is vibrated, the resistance force is cancelled and injection of the material liquid in a predetermined flow rate is allowed. This is because the liquid absorbing medium is in contact with the porous spray plate and a suctioning force for suctioning the material liquid from the liquid absorbing medium is generated by the vibration of the porous spray plate. Therefore, in the above construction, the material and the like of the liquid absorbing medium is specified or the vibration frequency, hole diameter, vibration width or the like of the porous spray plate is specified so that the amount of electrolyte sprayed from the spray port can be set to a desired amount.

Also, the spray device has an electrode pair for obtaining an electrolyte obtained by electrolyzing at least part of the material liquid. By this, the material liquid can be sprayed as the electrolyte, penetration into a human body or the like is improved, and a pharmacologic effect can be enhanced. Particularly, since the vibration is given to the electrolyte itself by ultrasonic vibration, components of the electrolyte are diffused and the surface area is expanded, by which an equivalent effect can be obtained with a smaller use amount of the electrolyte as compared with spraying without using the ultrasonic vibration. To such working effects, electrophoresis by electrolysis also contributes. Also, since the temperature of the electrolyte is raised by the electrolysis and ultrasonic vibration, viscosity of the electrolyte is lowered, which makes spray performance favorable (spraying is made easy). Moreover, since emulsification action is extremely improved by the electrolysis and ultrasonic vibration, a mixed amount of a surfactant in the electrolyte is decreased.

Thus, the material liquid in the material liquid tank penetrates into the liquid absorbing medium through a liquid passing port provided on the bottom surface of the material liquid tank and the liquid passage connected to the liquid absorbing medium, and the electrode pair is arranged on the liquid passage.

Also, in the spray device, the material liquid in the material liquid tank penetrates into the liquid absorbing medium from the passing port provided on the bottom surface of the material liquid tank through the liquid passage having a substantially circular section connected to the liquid absorbing medium, and the diameter of the liquid passage is set to the length of the liquid passage or longer. By this, a gas generated by the electrolysis can easily escape to the material liquid tank side (by which it is discharged to the outside), which can effectively prevent the air-lock phenomenon.

In the liquid passage, resisting unit for applying resistance to the flow of the liquid in the liquid passage and alleviating osmotic pressure of the liquid into the liquid absorbing medium is provided. By this, flow of the material liquid (or electrolyte) in the material liquid tank to the liquid absorbing medium more than necessary can be prevented, and injection of the electrolyte more than necessary from the liquid absorbing medium through the porous spray plate can be also prevented.

In the spray device, it is preferable that the material liquid tank is detachable to the housing. In this case, only the material liquid tank can be easily washed and the material liquid tank storing various liquids can be selectively used, by which convenience in use can be improved.

### EFFECT OF THE INVENTION

As mentioned in details in the above, according to the spray device of the present invention, since there is no need to provide a pump for pumping the material liquid to the spray unit, not only the weight, volume and costs of the entire spray device but power consumption of the entire device can be reduced. Also, operating noise (noise) or vibration caused by driving of the pump is eliminated and so-called air-lock phenomenon in use of the pump can be restricted. By providing the liquid passing adjusting unit for applying resistance to the flow of the material liquid in the liquid passage, dripping of the material liquid at the spray port is eliminated.

### BEST MODE FOR CARRYING OUT THE INVENTION

An embodiment of the present invention will be described below referring to the attached drawings. In the embodiment of the present invention described below, a type provided with electrode unit for electrolysis of a material liquid will be described, but the spray device of the present invention may be applied to a spray device not necessarily provided with the electrode unit.

FIGS. 1 to 3 show an embodiment of the present invention. As shown in FIGS. 1 and 2, a spray device 1 of the present invention comprises a housing 2 forming the device main body and a liquid-supply unit 4 detachably attached to the housing 2. In this case, the liquid-supply unit 4 has locking pieces 42 projected on the both sides and inserted to and locked by locking holes 40 formed in correspondence with the housing 2, and by having a pair of locking claws 44 formed on its upper-end edge locked by locking grooves 46 at the housing 2, the unit can be attached to the housing 2 (on the back face of the housing 2, for example). It is needless to say that the liquid-supply unit 4 is stored in the housing 2 not capable of detachment. FIG. 1 shows a state where the liquid-supply unit 4 is removed from the housing 2, while FIG. 2 shows a state where the liquid-supply unit 4 is attached to the housing 2.

The liquid-supply unit 4 comprises a material liquid tank 6 for reserving a predetermined material liquid, a pair of rod-state electrodes 19a, 19b for electrolyzing the material liquid, a liquid absorbing medium (sponge with high absorbing capacity, for example) 10 for absorbing electrolyte electrolyzed by the electrodes 19a, 19b, and a liquid passage (hereinafter referred to as a liquid passage) 8 having a substantially circular section for supplying the material liquid in the material liquid tank 6 to the liquid absorbing medium 10. Also, the housing 2 is provided with a spray portion 20 for spraying the electrolyte and a spray port 22 for allowing injection of the electrolyte to the outside.

FIGS. 3(a) and 3(b) show in detail the liquid-supply unit 4 and the spray portion 20 in the state where the liquid-supply unit 4 is attached to the housing 2.

As shown in the figure, the material liquid tank 6 arranged above the spray portion 20 and the liquid absorbing medium 10 in the attached state (state in FIG. 2) so that the material liquid 11 in the material liquid tank 6 can be smoothly guided toward the liquid absorbing medium 10. By this, the material liquid 11 in the material liquid tank 6 can be easily guided to the liquid absorbing medium 10 by action of force of gravity. Also, on the bottom surface of the material liquid tank 6, a liquid passing port 6a for having the inside of the material liquid tank 6 communicate with the liquid passage 8 is provided.

Also, the rod-state electrodes 19a, 19b are preferably arranged on right and left of the liquid absorbing medium 10 having it between them in the passage 8 on the immediate upstream side of the liquid absorbing medium 10, but it is only necessary that it is arranged in the passage 8. By flowing the material liquid between the electrodes 19a, 19b through the passage 8, the material liquid can be electrolyzed. In this embodiment, a distance between the electrodes 19a, 19b is set to 0.2 to 1.0 mm. Also, the diameter of the passage 8 is set longer than the length of the liquid passage 8. Moreover, in the liquid passage 8, resisting unit 47 is provided including a valve, a membrane or the like for alleviating osmotic pressure of the electrolyte into the liquid absorbing medium 10 by applying resistance to distribution of the material liquid 11 in the passage 8.

The spray portion 20 comprises a spray element arranged inside the housing 2 and an opening/closing cover 26 attached at an upper part on the outer surface of the housing 2. The spray element comprises a porous spray plate 23 and a piezo vibrator 21. On the back face of the porous spray plate 23, the liquid absorbing medium 10 is opposed in contact. Also, the porous spray plate 23 has a large number of through holes with the hole diameter of 18 to 24 μm and its end is fixed to the piezo vibrator 21. Therefore, by applying an alternating current or pulse voltage to the piezo vibrator 21 so as to vibrate the piezo vibrator 23, the porous spray plate 23 fixed to the piezo vibrator 21 can be vibrated. By this, the electrolyte absorbed in the liquid absorbing medium 10 in contact with the porous spray plate 23 receives a suctioning action by vibration of the porous spray plate 23 and is diffused/sprayed to the outside as fine droplets through the large number of through holes formed on the porous spray plate 23.

The opening/closing cover 26 exposes/hides the porous spray plate 23 and is attached to the housing 2 vertically slidably. The opening/closing cover 26 and the housing 2 have detecting unit for detecting the position of the opening/closing cover 26 in cooperation. FIG. 2 clearly shows a switch 39 on the housing 2 side constituting the detecting unit.

Also, in the housing 2, a control portion 36 incorporating a micro processor is provided. This control portion 36 controls application of a voltage to the electrodes 19a, 19b and driving of the vibrator 21 and receives a detection signal from the switch 39. Moreover, to a positive terminal and a negative terminal of an electrolytic power supply provided at the control portion 36, the electrodes 19a, 19b are electrically connected through wiring, not shown. The polarity of the power to be applied to the electrodes 19a, 19b can be switched by the control portion 36 with a predetermined time interval. By switching the polarity of the power to be applied by a predetermined period, a cathode-side electrolyte and an anode-side electrolyte are generated by a single electrode alternately, by which the anode-side electrolyte and the cathode-side electrolyte are mixed efficiently. The time interval to switch the polarity is preferably 2 to 1200 times/min and more preferably 120 to 600 times/min. Also, by switching the polarity, deposition of scale to the electrode can be effectively prevented. By the above electrolysis, the anode-side electrolyte and the cathode-side electrolyte are naturally mixed, and the mixed electrolyte in which the both electrolytes are mixed is continuously discharged to the spray portion 20 through the liquid absorbing medium 10. In the figure, reference numeral 32 denotes a power supply portion for supplying power to the electrodes 19a, 19b and the vibrator 21, and a dry-cell battery 30 or the like can be used as the power source in the power supply portion 32. Reference numeral 34 denotes a lid of the power supply portion 32.

Next, a case will be described that the material liquid (electrolyte in this embodiment) is sprayed using the above-constructed liquid spray device 1.

First, as shown in FIG. 2, in the state where the liquid-supply unit 4 is attached to the housing 2, part of the material liquid 11 in the material liquid tank 6 flows out of the liquid passing port 6a provided on the bottom surface of the material liquid tank 6 to the liquid passage 8 as shown in FIG. 3(b), fills the liquid passage 8, and penetrates into the liquid absorbing medium 10. When electrolyte is to be sprayed in this state, first, the opening/closing cover 26 is lowered downward from the closed state shown in FIG. 2 to the open state shown in FIG. 1. By this, the porous spray plate 23 is exposed to the outside through the spray port 22 and spraying is enabled. Also, with this opening of the opening/closing cover 26, the detecting unit is operated, and a detection signal indicating that the opening/closing cover 26 has been opened is transmitted from the switch 39 to the control portion 36. The control portion having received this detection signal supplies power of the power supply portion 32 to the piezo vibrator 21 and the electrodes 19a, 19b. In this case, by switching the polarity of the power applied to the electrodes 19a, 19b per predetermined period by the control portion 36, the cathode-side electrolyte and the anode-side electrolyte are alternately generated at a single electrode, the anode-side electrolyte and the cathode-side electrolyte are mixed efficiently and absorbed in the liquid absorbing medium 10. At that time, with supply of power from the power supply portion 32 to the piezo vibrator 21, the porous spray plate 23 is vibrated, and the electrolyte absorbed in the liquid absorbing medium 10 in contact with the porous spray plate 23 receives the suctioning action by vibration of the porous spray plate 23 and diffused/sprayed as fine droplets to the front of a porous plate 28a through the large number of fine through holes formed on the porous spray plate 23.

When the spraying of the electrolyte is finished and the spraying is stopped, the opening/closing cover 26 is pushed up. By this, a detection signal indicating that the opening/closing cover 26 is closed is transmitted from the detecting unit to the control portion 36. By this, the power supplied to the vibrator 21 and the electrodes 19a, 19b is disconnected, and the spraying of the electrolyte is stopped.

In the above configuration, the detecting unit in conjunction with the opening/closing cover 26 plays a role of an operation switch of electrolyte spraying, but not limited to this, it may be so configured that a power switch is provided separately and after the opening/closing cover 26 is opened, the spraying of the electrolyte is started by turning on the power switch. In this case, by setting such that the spraying of the liquid is started on an AND condition of the detecting unit and the power switch, the liquid is not sprayed when the opening/closing cover 26 is not lowered even if the power switch is turned on but erroneous spraying by wrong operation can be surely prevented.

Also, in the above configuration, the material liquid tank 6 is arranged above the liquid absorbing medium 10 and the material liquid 11 in the material liquid tank 6 is led to the liquid absorbing medium 10 by the action of force of gravity, but in this case, if the liquid level in the material liquid tank 6 is high, the electrolyte absorbed in the liquid absorbing medium 10 is easily pushed out by the material liquid pressure involved with the liquid level in the material liquid tank 6 toward the porous spray plate 23. On the other hand, if the liquid level in the material liquid tank 6 is low, the amount of the electrolyte passing through the liquid absorbing medium 10 is decreased, and if the liquid level in the material liquid tank 6 is extremely low, a water retaining capability by surface tension of the liquid absorbing medium 10 overcomes the pressure involved with the liquid level in the material liquid tank 6, and the electrolyte does not flow out of the liquid absorbing medium 10. However, when the porous spray plate 23 is vibrated, as mentioned above, the suction force suctioning the electrolyte from the liquid absorbing medium 10 is generated so that spraying can be carried out in a predetermined flow rate.

As described above, in the spray device 1 of this embodiment, since the liquid absorbing medium 10 is in contact with the material liquid 11 in the material liquid tank 6 all the time and the electrolyte absorbed in the liquid absorbing medium 10 is sprayed by vibration of the porous spray plate 21, a pump for pumping the material liquid 11 in the material liquid tank 6 is not provided. Therefore, not only the weight, volume and costs of the entire spray device 1 but power consumption of the entire spray device 1 can be reduced. Also, since a pump is not provided, operating noise (noise) or vibration caused by driving of the pump is not generated and so-called air-lock phenomenon in use of the pump can be restricted. That is, since a gas generated by electrolysis does not receive a pumping force by a pump, it is not forcedly pushed away to the porous spray plate 23 but escapes to the material liquid tank 6 and is discharged, or it is absorbed by the liquid absorbing medium 10 and then, discharged to the outside while being diffused by vibration of the porous spray plate 23. Also, since a pump is not provided, time for filling a pump and a liquid passage of the pump with a material liquid (electrolyte solution) is not required at initial liquid filling, the electrolyte can be sprayed immediately after the liquid filling, and a liquid passage difficult to be washed is not present, which is hygienic. Moreover, since there is no liquid collected a pump, the material liquid 11 can be used efficiently.

In this embodiment, the liquid absorbing medium 10 also has a function as liquid passing resisting unit. That is, the liquid absorbing medium 10 applies a resisting force to restrict its outflow from the spray port 22 to the electrolyte distributing through the liquid absorbing medium 10 when the porous spray plate 23 is not vibrated, and when the porous spray plate 23 is vibrated, the resisting force is cancelled and injection of a predetermined flow rate of the electrolyte is allowed. This is because the liquid absorbing medium 10 is in contact with the porous spray plate 23, and a suction force for suctioning the electrolyte from the liquid absorbing medium 10 is generated by vibration of the porous spray plate 23. Therefore, in this embodiment, by specifying the material and the like of the liquid absorbing medium 10 or the frequency of vibration, hole diameter, vibration width or the like of the porous spray plate 23, the amount of the electrolyte sprayed from the spray port 22 can be set to a desired amount.

Also, in this embodiment, the entire electrolyzed electrolyte is sprayed. Therefore, there is no electrolyte discharged as a waste liquid from the electrolytic area and thus, a waste liquid tank for receiving the waste liquid does not need to be provided in the housing. Therefore, if the size is the same as that of a conventional spray device having a waste liquid tank, a larger installation space can be ensured for the material liquid tank 6 by the portion obtained after the waste liquid tank is eliminated, and a volume of the material liquid tank 6 can be ensured larger. On the other hand, if the material liquid tank 6 with the volume as before is used, the size of the device can be reduced by the portion of elimination of the waste liquid tank.

Also, in this embodiment, since a liquid is electrolyzed and sprayed ultrasonically, penetration into a human body is improved by electrolysis and ultrasonic vibration. Particularly, the ultrasonic vibration gives vibration to the electrolyte itself, components of the electrolyte is diffused and the surface area is expanded, by which an equivalent effect can be obtained with a smaller use amount of the electrolyte than a case of spraying without using the ultrasonic vibration. Electrophoresis by electrolysis also contributes to this working effect. Also, since the temperature of the electrolyte is raised by electrolysis and ultrasonic vibration, viscosity of the electrolyte is lowered and spray performance is improved (easy to spray). Moreover, since emulsification action is extremely improved by electrolysis and ultrasonic vibration, a mixed amount of a surfactant in the electrolyte is decreased.

Also, in this embodiment, the material liquid tank 6 (liquid-supply unit 4) is detachably attached to the housing 2. Thus, the material liquid tank 6 can be easily washed and the liquid-supply unit 4 having the material liquid tank 6 accommodating various liquids can be selectively used, which is convenient in use.

Also, in this embodiment, if the pair of electrodes 19a, 19b arranged in the passage 8 are arranged right and left of the liquid absorbing medium 10 with the medium between them, it is possible to absorb the entire electrolyte in the liquid passage 8. Also, since the electrodes 19a, 19b are in the rod state, the passing resistance of the liquid passing between the electrodes 19a, 19b can be reduced. Also, since the interval between the electrodes 19a, 19b is as small as 0.2 to 1.0 mm, the spray device 1 can be configured in a compact manner.

Also, in this embodiment, since the diameter of the liquid passage 8 is set longer than the length of the liquid passage 8, the gas generated by electrolysis can easily escape toward the material liquid tank 6 (by which it is discharged to the outside), which can effectively prevent the air-lock phenomenon.

Also, in this embodiment, the resisting unit 47 is provided for alleviating the osmotic pressure of the electrolyte into the liquid absorbing medium 10 by applying resistance to distribution of the liquid in the passage 8. Therefore, the material liquid in the material liquid tank 6 is prevented from flowing toward the liquid absorbing medium 10 more than necessary, and injection of the electrolyte more than necessary from the liquid absorbing medium 10 through the porous spray plate 23 can be prevented.

In this embodiment, configuration as shown in FIG. 4 can be considered as a variation. That is, the internal space of the passage 8 is divided by a partition portion 60 into two parts, and in one space 8b in the liquid passage 8 divided by the partition portion 60, the electrode pair 19a, 19b for electrolyzing the material liquid distributing therein are arranged, while in the other space 8a, the material liquid from the material liquid tank 6 is distributed as it is, and the electrolyte from the one space 8b and the material liquid from the other space 8a are mixed together at a connection portion between the passage 8 and the liquid absorbing medium 10 and sprayed.

As above, the internal space of the liquid passage 8 is divided into two parts and the material liquid and the electrolyte are distributed in these spaces 8a, 8b, respectively, and the both liquids are mixed and fed into the liquid absorbing medium 10 so that even if the gas generated by electrolysis is suctioned to the liquid absorbing medium 10, the suctioned gas is discharged to the outside from the liquid absorbing medium 10 by the flow resistance of the material liquid not accompanied by the gas. As a result, defective spraying by the gas can be prevented and stable spraying is enabled.

In this configuration, the partition portion 60 does not have to be formed as a shielding member completely dividing the space into two spaces 8a, 8b, but it may be a mesh-state portion. Also, without providing the partition portion 60, a mesh-state filter 90 may be arranged between the electrodes 19a, 19b and the liquid absorbing medium 10 as shown in FIG. 5. In this case, since the gas (bubbles) generated by electrolysis can be crushed by the filter 90, the air-lock phenomenon can be prevented.

FIG. 6 shows a first variation of the liquid-supply unit 4. As shown in the figure, in this variation, the pair of electrodes 19a, 19b are made of flat plane electrodes and installed in the material liquid tank 6. Also, a distance between the electrodes 19a, 19b is maintained by a spacer 25 to a given dimension. The other configuration is basically the same as the embodiment mentioned above.

According to this configuration, since the electrodes 19a, 19b are installed in the material liquid tank 6, the installation space for the electrodes 19a, 19b does not have to be provided outside the material liquid tank 6, and the spray device 1 can be formed compact.

FIG. 7 shows a second variation of the liquid-supply unit 4. As shown in this figure, in this variation, the pair of electrodes 19a, 19b are made of flat plate electrodes and arranged in an electrolysis tank 39 provided between the liquid absorbing medium 10 and the material liquid tank 6. In the electrolysis tank 39, an opening 39a communicating with the material liquid tank 6 is formed. Also, the liquid absorbing medium 10 is arranged at an upper part in the electrolysis tank 39 and pumps up the electrolyte in the electrolysis tank 39 using capillary action. The other configuration is basically the same as the above-mentioned embodiment.

According to the configuration, since the liquid absorbing medium 10 arranged at the upper part of the electrolysis tank 39 pumps up the electrolyte in the electrolysis tank 39 using the capillary action, only by having the material liquid in the material liquid tank 6 and the liquid absorbing medium 10 in contact with each other all the time, there is no need to arrange the material liquid tank 6 above the liquid absorbing medium 10 any more.

FIG. 8 shows a variation of the liquid-supply unit 4 and the injection portion 20. As shown in this figure, in this variation, the pair of electrodes 19a, 19b are made of a first and a second flat plate electrodes arranged so as to hold the liquid absorbing medium 10 on the upstream side and the downstream side of the liquid absorbing medium 10. Since these flat plate electrodes 19a, 19b are arranged so as to shut off the flow passage of the passage 8, a large number of through holes allowing distribution of the liquid are provided on the surfaces. Also, in this variation, the first flat plate electrode 19a located on the downstream side of the liquid absorbing medium 10 is a cathode serving also as the porous spray plate 23, while the second flat plate electrode 19b located on the upstream side of the liquid absorbing medium 10 is an anode.

In this configuration, since the liquid absorbing medium 10 is in contact with the electrodes 19a, 19b, the gas generated at the electrodes 19a, 19b are directly absorbed by the liquid absorbing medium 10, and the air-lock phenomenon can be effectively prevented. Also, since the first porous flat plate electrode 19a also serves as the porous spray plate 21, the number of parts can be reduced, and then, the manufacturing costs can be lowered and the size of the spray device can be made compact.

The spray device of the present invention can be also applied to the case of application or spraying of mixed electrolyte to the skin of a human body or the like (colon, sunscreen, disinfection, burn treatments, washing after excretion in a toilet and the like), hair (coloring, perm solution, bed-head fixing, shampooing, conditioner, treatment), scalp (medicated tonic, hair-growth tonic, tonic), eyelash (eyelash curling and the like), eyes (eyeball disinfection, washing and the like), oral (disinfection, oral inflammation treatments and the like), tooth (toothpaste, tooth enamel and the like), and nail (nail-art drug, polisher, nail nutrition and the like) by giving ultrasonic vibration to a material liquid (electrolyte solution) for cosmetic or hygienic drugs or an electrolyte obtained by electrolyzing it so as to improve penetration into the human body.

### INDUSTRIAL APPLICABILITY

The present invention relates to a spray device for spraying a material liquid, which is an electrolyte solution, or an electrolyte obtained by electrolyzing it used for cosmetic or hygienic purpose without using pumping unit such as a pump and has an industrial applicability.

### BRIEF DESCRIPTION OF THE DRAWINGS

FIG. 1 is an exploded perspective view of a spray device according to an embodiment of the present invention;

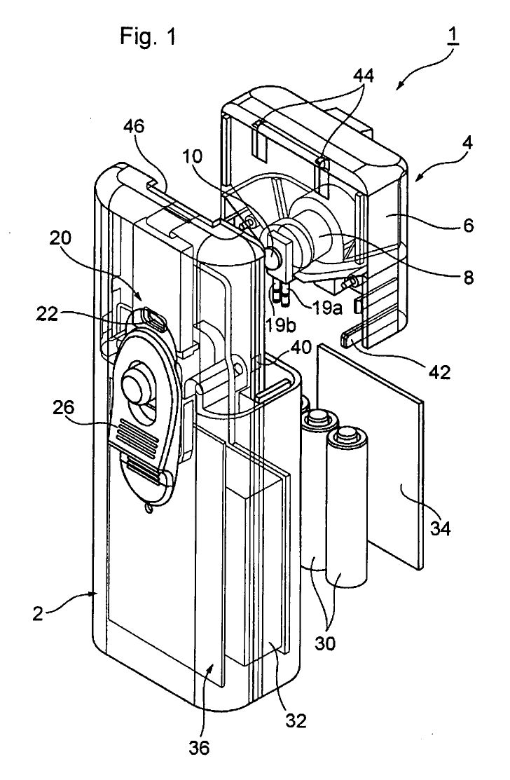

FIG. 2 is a perspective view of an assembled state of the spray device in FIG. 1;

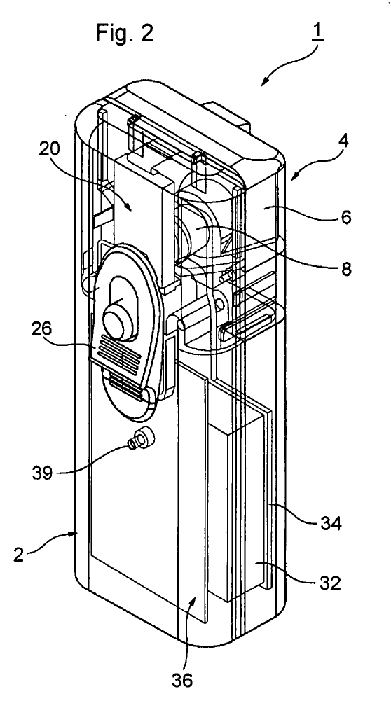

FIG. 3(a) is a detailed perspective view of a liquid-supply unit and a spray portion in the state where the liquid-supply unit is attached to a housing and FIG. 3(b) is its sectional view;

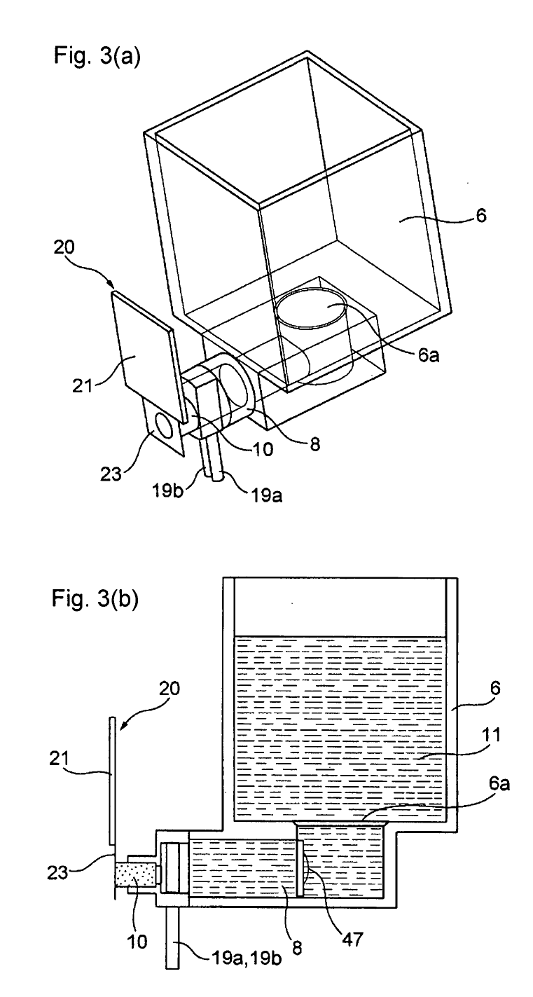

FIG. 4(a) is an exploded perspective view according to another variation of the liquid-supply unit and the spray portion and FIG. 4(b) is its sectional view;

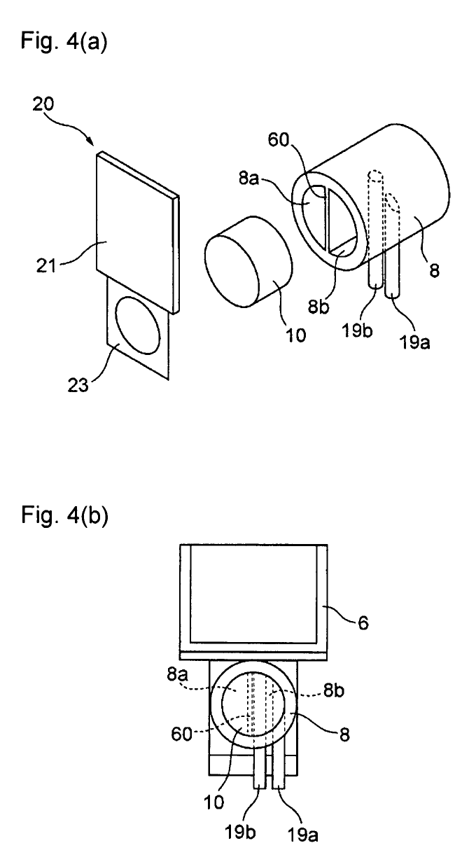

FIG. 5 is a sectional view according to still another variation of the liquid-supply unit and the spray portion;

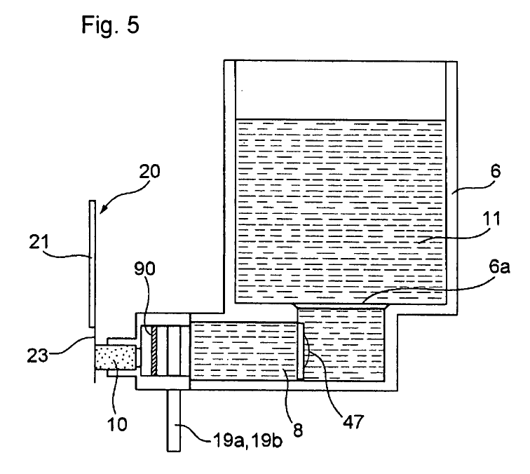

FIG. 6(a) is a perspective view according to a first variation of the liquid-supply unit and FIG. 6(b) is its sectional view;

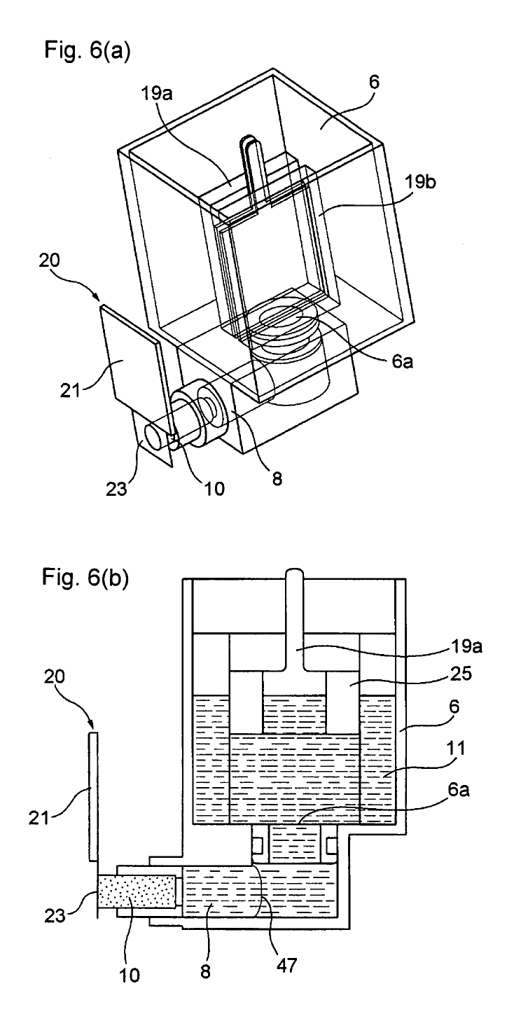

FIG. 7(a) is a perspective view according to a second variation of the liquid-supply unit and FIG. 7(b) is its sectional view;

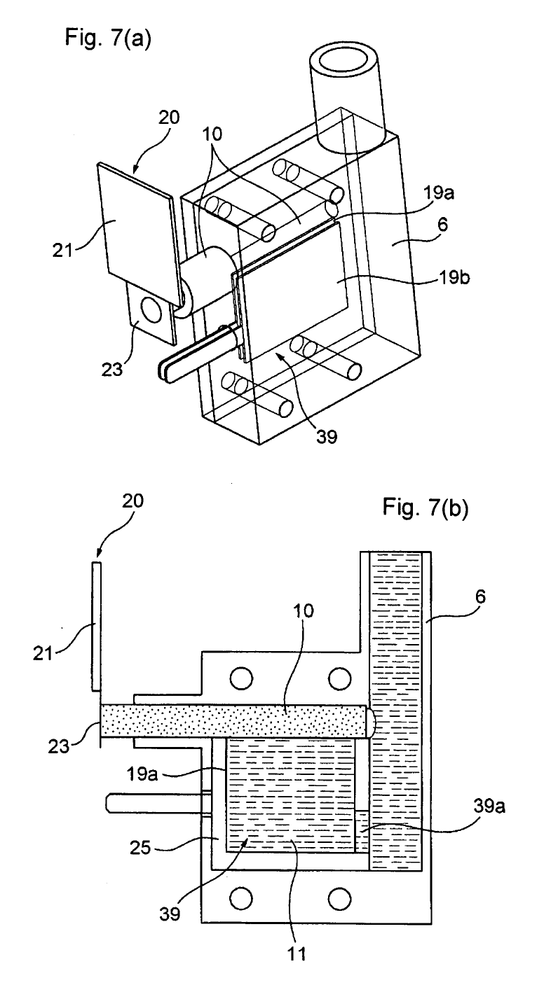

FIG. 8(a) is a perspective view according to a variation of the liquid-supply unit and the spray portion and FIG. 8(b) is its sectional view;

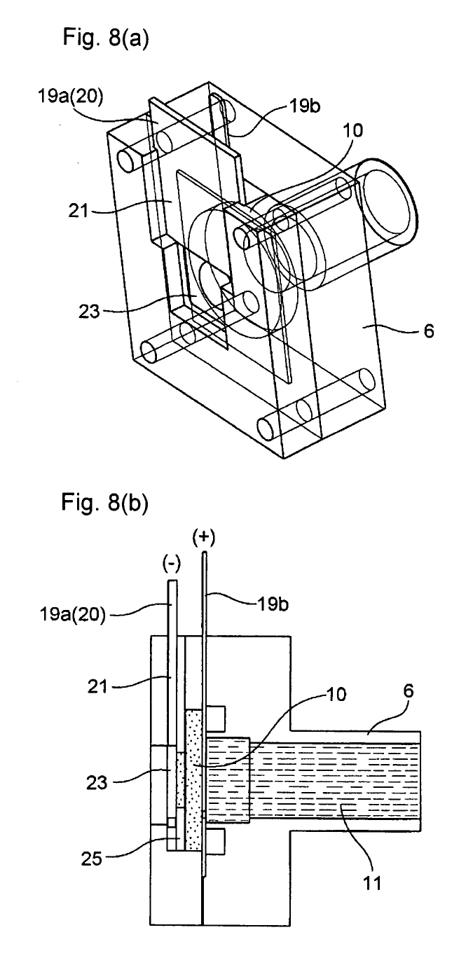

FIG. 9 is an outline block diagram of a conventional spray device; and

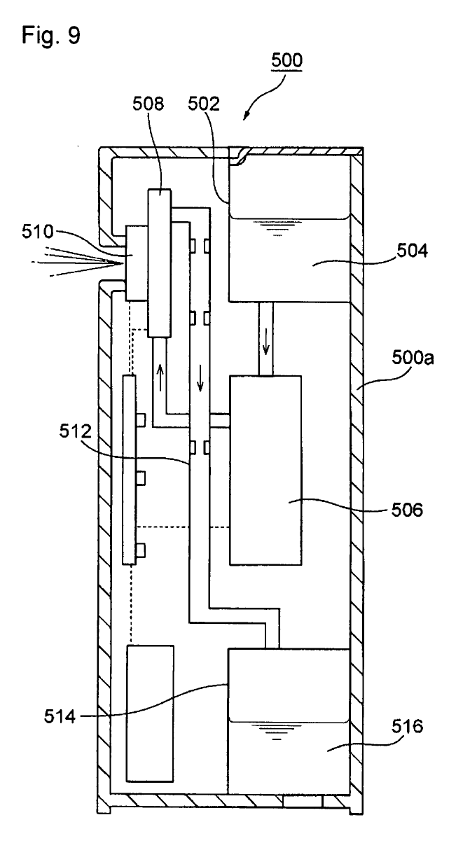

FIG. 10(a) is a detailed perspective view around a spray portion in the conventional spray device and FIG. 10(b) is its sectional view.

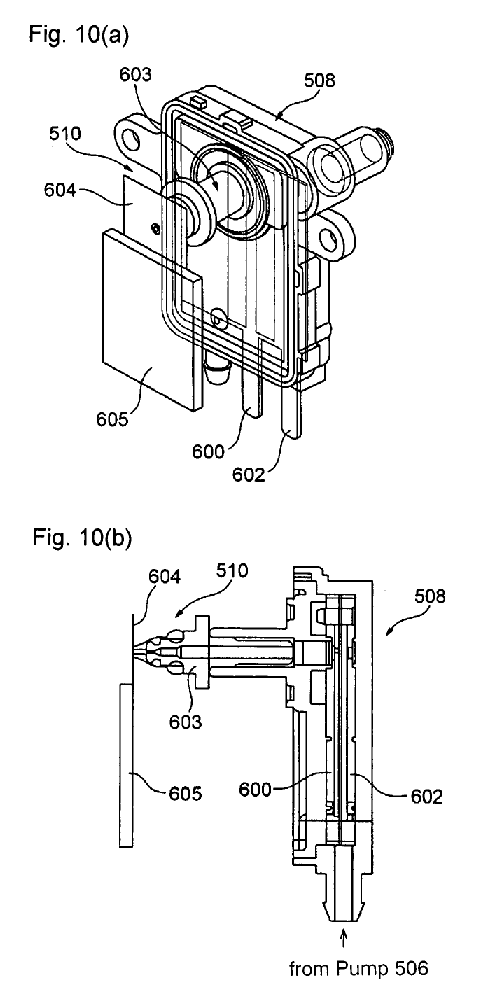

### EXPLANATION OF REFERENCE NUMERALS

1 Spray device
2 Housing
6 Material liquid tank
8 Liquid passage
10 Liquid absorbing medium
11 Material liquid
19a, 19b Electrode
20 Spray portion
21 Vibrator
23 Porous spray plate

1. A spray device comprising:
a housing;
a material liquid tank attached to or stored in the housing and reserving a predetermined material tank;
spray unit having a spray port for spraying the material liquid to the outside; and
a liquid passage for having the material liquid tank and the spray unit communicate with each other, wherein
the material liquid tank is arranged above the spray unit, and the liquid passing adjusting unit in contact with the spray unit and applying resistance to a flow of the material liquid according to a spray amount from the spray unit is provided between the liquid passage and the spray unit.

2. The spray device according to claim 1, wherein
the liquid passing adjusting unit is formed by a liquid absorbing medium absorbing the material liquid.

3. The spray unit according to claim 2, wherein the liquid absorbing medium is a sponge material.

4. The spray device according to claim 2, wherein
the spray unit has:
a spray plate having a large number of fine holes; and
a vibrator for vibrating the spray plate.

5. The spray device according to claim 2, wherein
an electrode pair is provided for obtaining an electrolyte obtained by electrolyzing at least part of the material liquid.

6. The spray device according to claim 5, wherein
the electrode pair is arranged on the spray unit side in the liquid passage.

7. The spray device according to claim 2, wherein
the material liquid in the material liquid tank penetrates into the liquid absorbing medium from a passing port provided on the bottom surface of the material liquid tank through a liquid passage having a substantially circular section connected to the liquid absorbing medium; and
the diameter of the liquid passage is longer than the length of the liquid passage.

8. The spray device according to claim 2, wherein
resisting unit for applying resistance to the flow of the liquid in the liquid passage and for alleviating osmotic pressure of the liquid into the liquid absorbing medium is provided in the liquid passage.
